(19) United States
(12) Patent Application Publication
(10) Pub. No.: US 2010/0027974 A1
(43) Pub. Date: Feb. 4, 2010

(54) Self Configuring Media Player Control

(75) Inventor: Juned Ansari, Broken Arrow, OK (US)

Correspondence Address: Fellers, Snider, Blankenship, Bailey & Tippens, Suite 800, 321 S. Boston, Tulsa, OK, 74103-3318, US

(73) Assignee: Level 3 Communications, Inc., Broomfield, CO (US)

(21) Appl. No.: 12/184,154

(22) Filed: Jul. 31, 2008

(51) Int. Cl. H04N 7/26

(52) U.S. Cl. 386/124

(57) ABSTRACT

An apparatus and method for use in the playback of media assets is disclosed. Preferably, the apparatus includes at least a processor programmed with media request software, a network interface device communicating information between the processor and a network, and a non-volatile information storage medium loaded with media player program logic responsive to and interacting with the media request software, and a media player object library supporting a plurality of media player decoder modules responsive to and interactive with the media player program logic. Preferably, the non-volatile information storage medium communicates with the processor, and upon receipt by the network interface device of media requested from the network, the media player program logic analyzes the received media to determine in which format the media was received, and then automatically selects a media player decoder module from the plurality of media player decoder modules for playback of the received media.

### FIELD OF THE INVENTION

This invention relates to media players, and in particular, but not by way of limitation, to a self configuring media player having an ability to detect a media format of an available analog or digital media and configure on the fly a media player control compatible with and configured for playback of the available analog or digital media.

### BACKGROUND

Growth in the creation and distribution of music, video, software and other media assets has been dramatically transformed by the digital age and the Internet. Part of this growth has resulted in an array of media formats used to create and playback these media assets. Additionally, for example, distribution of music is evolving from a physical copy sold by retail stores, catalog companies or on-line vendors, to digital copies transmitted over the Internet. In this connected and digital world, a system and method are needed whereby users can use media assets from multiple devices without the need to have a separate media player tool for each type of media asset a user wishes to access. Accordingly, it would be desirable to provide a system and method that allows for a media player tool to self adapt, on the fly by configuring a media player control compatible with and configured for playback of the available analog or digital media of interest to a user, and be adaptable across a plurality of different devices that are capable of connecting to a source of the media assets directly or indirectly over one or more communication networks.

### SUMMARY OF THE INVENTION

In accordance with preferred embodiments, a device includes at least a processor programmed with media request software, a network interface device communicating information between the processor and a network, and a non-volatile information storage medium loaded with media player program logic responsive to and interacting with the media request software, and a media player object library supporting a plurality of media player decoder modules responsive to and interactive with the media player program logic. Preferably, the non-volatile information storage medium communicates with the processor, and upon receipt by the network interface device of media requested from the network, the media player program logic analyzes the received media to determine in which format the media was received, and then automatically selects a media player decoder module from the plurality of media player decoder modules for playback of the received media.

A preferred embodiment further includes a graphical display device responsive to the processor, a media player control loaded onto the non-volatile information storage medium, responsive to the media player program logic, and interacting with the graphical display device to provide a graphical user interface for use by a user in playing back the received media, and a media player configuration module loaded onto the non-volatile information storage medium. Preferably, the media player configuration module interacts with the media player program logic, to integrate the selected media player decoder with the media player control for use by the user in playing back the received media.

In an alternate preferred embodiment, a method is provided by steps that include at least, programming a processor with media request software, providing a network interface device communicating information between the processor and a network, and loading media player logic on a non-volatile information storage medium responsive to the processor, and in which the media player logic is responsive to and interacting with the media request software. The preferred method further includes the steps of loading onto the non-volatile information storage medium a media player object library supporting a plurality of media player decoder modules responsive to and interactive with the media player program logic, requesting media from the network via the media request software, and receiving media requested from the network. Once the requested media has been received, the preferred method continues with the steps of analyzing in which format the received media is presented using the media player program logic, and automatically selecting a media player decoder module from the plurality of media player decoder modules for playback of the received media.

These and various other features and advantages that characterize the claimed invention will be apparent upon reading the following detailed description and upon review of the associated drawings.

### BRIEF DESCRIPTION OF THE DRAWINGS

FIG. 1 shows a block diagram of a media asset playback system configured in accordance with a preferred embodiment of the present invention.

FIG. 2 illustrates a block diagram of a user playback device of the configured media asset playback system of FIG. 1.

FIG. 3 illustrates a block diagram of a plurality of metadata files of a style sheet module of the user playback device of FIG. 2.

FIG. 4 shows a block diagram of a portal of the media asset playback system of FIG. 1.

FIG. 5 depicts a block diagram of a plurality of the media asset sources of the playback system of FIG. 1.

FIG. 6 reveals a flow chart of a preferred method of using the playback system of FIG. 1.

FIG. 7 reveals a flow chart of an alternate preferred method of using the playback system of FIG. 1.

### DETAILED DESCRIPTION OF A PREFERRED EMBODIMENT

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

Reference will now be made in detail to one or more examples of the invention depicted in the figures. Each example is provided by way of explanation of the invention, and not meant as a limitation of the invention. Referring to FIG. 1, shown therein is a preferred embodiment of the present invention, which is directed to a system 100 for distributing digital media assets from a variety of media asset sources 102 to a user playback device 104 through a portal 106 via a communication network 108.

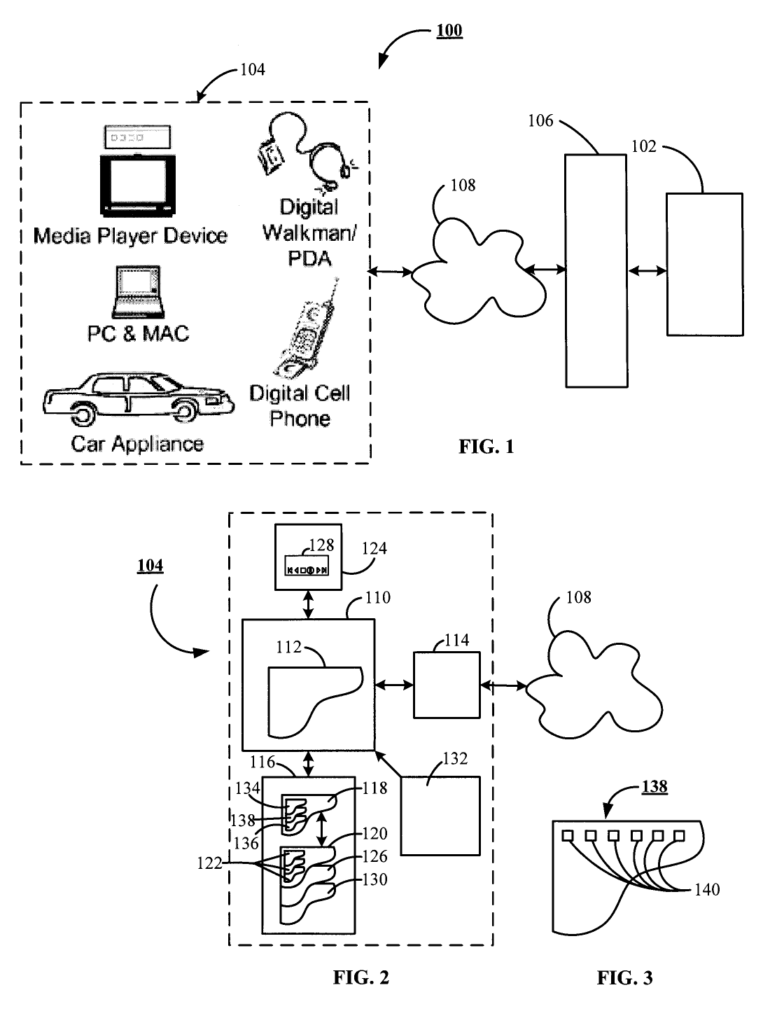

Preferably the user playback device 104 may be any of a variety of devices that include, but is not limited to: autos; personal computers; cell phones; PDA's; media player devices; and work stations. In a preferred embodiment of the present invention, as shown by FIG. 2, the playback device 104 supporting a self configuring media player includes at least a processor 110 programmed with media request software 112, a network interface device 114 communicating information between the processor 110 and the network 108, and a non-volatile information storage medium 116 loaded with media player program logic 118 responsive to and interacting with the media request software 112, and a media player object library 120 supporting a plurality of media player decoder modules 122 responsive to and interactive with the media player program logic 118.

Preferably, the non-volatile information storage medium 116 communicates with the processor, and upon receipt by the network interface device 114 of media requested from the network 108, the media player program logic 118 analyzes the received media to determine in which format the media was received, and then automatically selects a media player decoder module 122 from the plurality of media player decoder modules for playback of the received media.

The preferred embodiment shown by FIG. 2 further includes a graphical display device 124 responsive to the processor 110, a media player control 126 loaded onto the non-volatile information storage medium 116, responsive to the media player program logic 118, and interacting with the graphical display device 124 to provide a graphical user interface 128 for use by a user in playing back the received media, and a media player configuration module 130 loaded onto the non-volatile information storage medium 116. Preferably, the media player configuration module 130 interacts with the media player program logic 118, to integrate the selected media player decoder 122 with the media player control 126 for use by the user in playing back the received media.

The preferred embodiment of FIG. 2 also shows that the playback device 104 additionally includes a pointing device 132 communicating with the processor 110 and interacting with the media player control 126, wherein the user interacts with the graphical display device via manipulation of the pointing device 132 to stimulate the media player control 126 to playback the received media. The pointing device 132 may include for example, but is not limited to, a game controller, a keyboard, a mouse, a touch screen, or any other device that functions to allow a use interaction with the graphical display device 124. As further shown by FIG. 2, the media player program logic 118 preferably includes media format recognition logic module 134, which interacts with the media request software 112, for use in analyzing which format the received media is presented, a presentation layer code 136, and a style sheet module 138 providing a plurality of metadata files 140, as shown by FIG. 3. Preferably each metadata file 140 provides specific presentation control information for use in controlling playback of the received media.

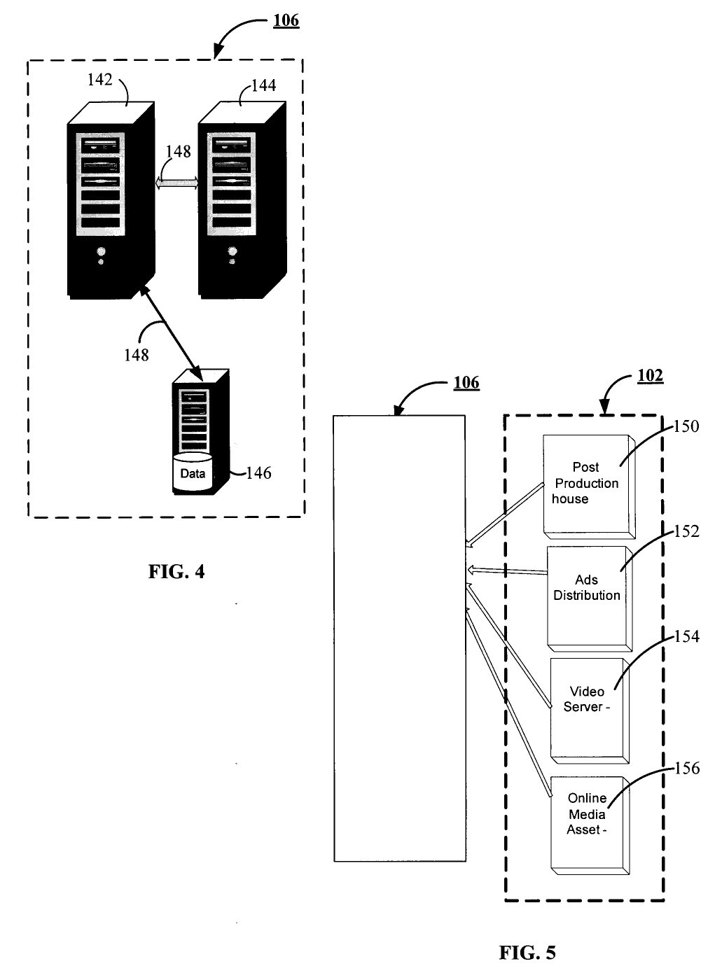

In the preferred embodiment shown by FIG. 4, the portal 106 preferably includes a web server 142, such as one or more computer servers running on an operating system, a master media library server 144, database sever 146 and a broadband interface 148. While in the preferred embodiment shown by FIG. 5, the variety of media asset sources 102 include, but are not limited to, a post production house 150, an ads-distributor 152, a video server 154 containing a library of video assets such as movies and other video productions from one or more production companies, and a web site 156 for an online media asset company.

In addition, artists not affiliated with a mainstream production company may make their video and/or audio assets available from a host server or their own servers. The portal 106 connects to the media asset sources 102 by any suitable means, such as the Internet, dedicated telecommunication lines, wireless networks, dedicated wide area networks, or any combination thereof. The terminology “electronically transmitting” a digital media asset is meant to include wired and/or fiber communication, wireless communication, and any long-distance or short range communications (IEEE 802.11, HomeRF, BlueTooth™) or combinations thereof. In addition to downloading or streaming media assets stored locally on the portal 106, the media player control 126 connects to media asset sources 102 through the portal 106 and downloads and/or streams media assets.

A media player control 126 is a control that enables a user to play a digital media asset. The media player control 126 may be used on electronic media enabled device such as laptop, digital phones, monitor, television and etc. The media player control 126 is also referred to as a user control insofar as it acts as a user control to the portal 106 in some circumstances.

Briefly, a media player control 126 comprises a software process that executes a media playback software application program to enable a user to play a digital media asset, such as music, video, games, etc. The media playback software application program may be a platform generic software program that is useful on a diverse variety of media player devices.

A user will have one media player control 126 and therefore desire access to media assets that he/she has purchased the rights to, on media player control, if that user has purchased rights of sufficient scope to permit access on multiple media. Those assets to which a user has purchased digital access rights on one or more media players are hereinafter referred to as a user's licensed assets. The portal 106 is a computer server or group of servers that functions to allow for the storage, stream and download of media assets to a media player control 126. In addition, as described above the portal 106 provides connections to other source sites, such as sources of streaming Internet radio providers.

The portal 106 allows for synchronization and replication of a user's licensed assets with each of the user's media player control 126. This functionality is hereinafter referred to as the virtual media asset library. The master media library server 144 serves as a central repository within which media assets are “tagged” with identity and access privileges of those users (and users within a user family) that have licensed rights in the media assets. The portal 106 may be accessible directly from a media player control and through one or more web sites and may provide a customizable interface or view to each user, if desired.

The digital media assets distributed by the system may be audio such as music, video such as movies, television programs or other video productions, interactive software games, or any media that is digitized and suitable for electronic distribution. The digital media asset may be protected, where applicable or necessary, from piracy by the use of various methods, including digital rights asset management (DRM), encryption and watermarking. The digital media assets may be in any known or hereinafter developed formats, such as, for example, MP3, EPAC, WAV, REAL, MPEG, QuickTime and other formats.

Preferably, the portal 106 of FIG. 4, communicates with the user playback device 104 via the network 108 that may consist of the Internet and/or a combination of wireless communication networks, such as cellular networks, PCS networks, etc. While a single portal 106 is shown in FIG. 1, it should be understood that there may be multiple portals, each dedicated to serve subsets of media player devices in a distributed fashion so as to minimize load on individual servers.

In accordance with one aspect of a preferred embodiment, the web server 142 synchronizes the licensed digital media assets for a user with the client database application in media player control of the user so that a user can access any licensed media asset from any of the user's media players control for which that user has licensed rights. Alternatively, for media player control that do not have a database client application, the database sever 146 maintains the user's database of assets “on-line” and a user obtains access to it by connecting to the portal 106. The web server 142 accesses the requested media from master media server 144. The database server 146 keeps user and media information which is used by the web server 142.

In a network playback mode, the media player control is connected to a networked server or a mounted hard drive on a computer, which is on its local network. A media player process is capable of playing media assets in this mode from any connected server. In an internet streaming mode, the media player process interacts with an Internet-based source for music or video, such as the portal or other sites capable of streaming audio or video data. Additionally, the media player process is capable of adding URL reference to its playlist. Streaming data formats include MP3, EPAC, Windows Media Audio and Video, Flash, QuickTime and REAL audio and REAL video.

In a preferred embodiment, a client database application of the media player can replicate its database list to the portal for virtual asset sharing. The client database application is, for example, 8iLite Oracle or SQL database software. The client database application allows the media player user to access files stored at the portal 106 in his/her virtual media asset library. Additionally, merchants can elect to sell digital media assets along with the sale of, for example, a hardcopy CD or Video. This feature can provide an additional revenue stream to the record companies as well as to the CD retailers. The client database in the media player and the master media library database communicate and interact to provide automatic replication and synchronization.

An example of how the preferred system operates to distribute digital media assets from a media source 102 to a user playback device 104 is now described with reference to FIGS. 1-2. Initially, a user becomes a member or subscriber to a portal 106, at which time his or her identity is initialized, and he/she is issued a user-specific password. Once a membership exists, bases on level of permission use will be granted access to perform multiple operations. If a user has been granted access to subset of media asset library then he/she can access media using client interface via the portal 106. The master media library server 144 need not locally store all of the media assets; in some cases the master media library server 144 will maintain a reference to the media asset that is stored by a media source 102 and accessed by the portal 106 as needed to satisfy the needs of users.

The portal 106 may distribute digital media assets that are downloaded in their entirety, to a user playback device 104 and play them back on a media player control 126. Alternatively, the portal 106 may stream the digital media assets to a user playback device 104 and play them back on the media player control 126. The portal 106 applies a series of rights management rules associated with each user's tagged digital media assets to limit the user's access to and use to those periods to which the user's licensed rights of those assets applies. Depending upon the specific licensing arrangement between a digital media asset owner and the user, the rights management rules can provide for a limited number of plays or uses of a particular asset, a limited number of days during which the asset can be used, or a limited number of other individuals with which the user may share the asset.

A digital media asset may be encrypted for general protection when the asset is first entered as an object within the main library database server. Upon the request for a download (or streaming access) by a user, the asset may be watermarked to coincide with the serial number of the user's family of client media player devices. Each client media player device that the user owns becomes a licensed playback device for his or her registered multimedia assets if the scope of that license so permits. For example, if a user owns five client media player devices capable of running the playback engine, the user will have access to those assets from one client media player device to another in seamless fashion. This example illustrates a capability of the system of the present invention to move or copy an asset from any home, car, portable, computer, or other computing device. Each client media player device has a stored protection key that is capable of decrypting and executing the object that has been downloaded to the player. Each client media player device key is unique, but will have some level of identity with the other client media player devices used by the user's family of devices. From an auditing and security standpoint, each client media player device maintains a log of its playback or use activity for purposes of reconciliation with the media library database server application. From the point of download of the asset forward, the asset will be associated with and licensed to the user's family of client media player devices. Furthermore, with the permission of a digital media asset owner or licensor, a user may be granted the right to loan or forward his or her licensed media assets to another person that is not a registered user of the system. The forwarded asset is encapsulated in an executable file that allows for the object's integration into the recipient's media players, provided the players are compatible with the media player technology of the system. If compatibility exists, the recipient will have the executable rights associated with this object. That is to say that if the rights of the object include an ability to play the asset only once, then the asset will play or be used once, and further actions will be disabled. In the event that compatibility does not exist or the recipient's device does not have a media player, the object will prompt for the optional download of a media player engine software application. In addition, the object will offer the possibility of membership to the system to allow for the recipient's use of this asset, as well as the recipient's possible downloading and use of other digital media assets.

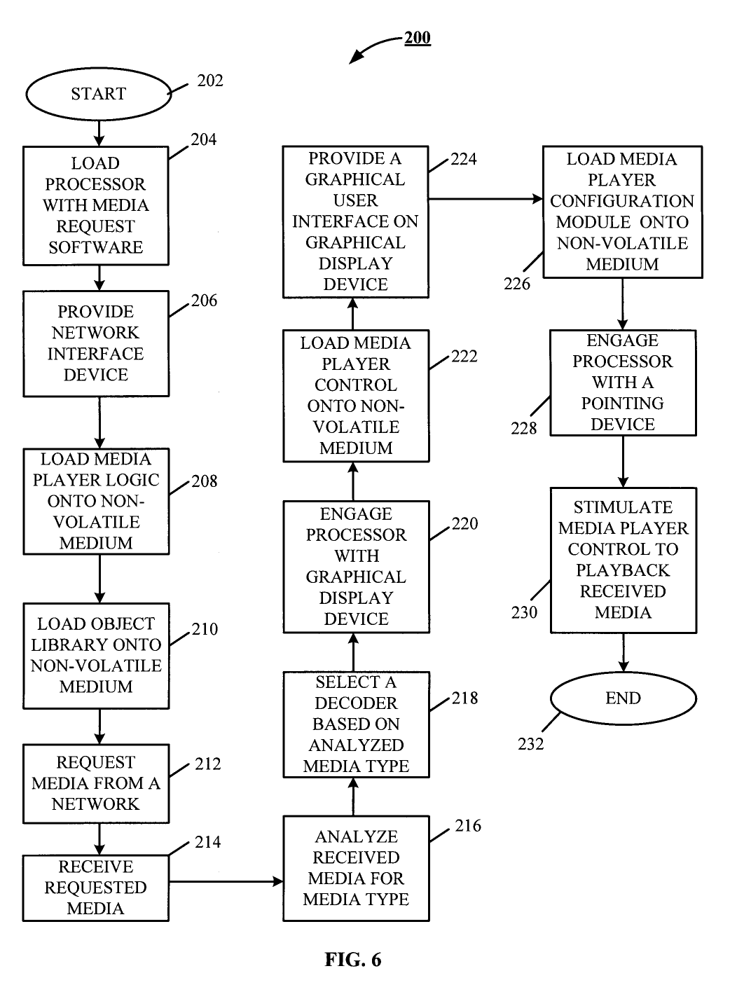

Turning to FIG. 6, shown therein is a flow chart 200 that depicts process steps of a method of using a self configuring media playback system. The method commences at start process step 202 and proceeds to process step 204 with programming a processor with media request software. At process step 206, a network interface device is provided for communication between the processor and a network. At process step 208, media player logic is loaded onto a non-volatile information storage medium, which is responsive to the processor. Additionally, the media player logic is responsive to and interacting with the media request software.

At process step 210, a media player object library supporting a plurality of media player decoder modules responsive to and interactive with the media player program logic loading onto the non-volatile information storage medium, and at process step 212, the media request software requests media from the network. At process step 214, the requested media is received, and at process step 216, using the media player program logic, the received media is analyzed to determine in which format the media is presented. At process step 218, a media player decoder module is automatically selected from a plurality of media player decoder modules for playback of the received media.

The process continues at process step 220, with an engagement of the processor with a graphical display device responsive to the processor. At process step 222, the non-volatile information storage medium is loaded with a media player control responsive to the media player program logic and interacting with the graphical display device. The media player control providing a graphical user interface for use by a user in playing back the received media. At process step 224, the selected media player decoder is integrated with the media player control for use by the user in playing back. By initiating the media player configuration module, the received media interacts with the media player program logic. At process step 226, a media player configuration module is loaded onto the non-volatile information storage medium, and the processor is engaged by a pointing device, which is used to manipulate the media player control at process step 228. At process step 230, the manipulation of the media player control results in the playback of the received media, and the process concludes at end process step 232.

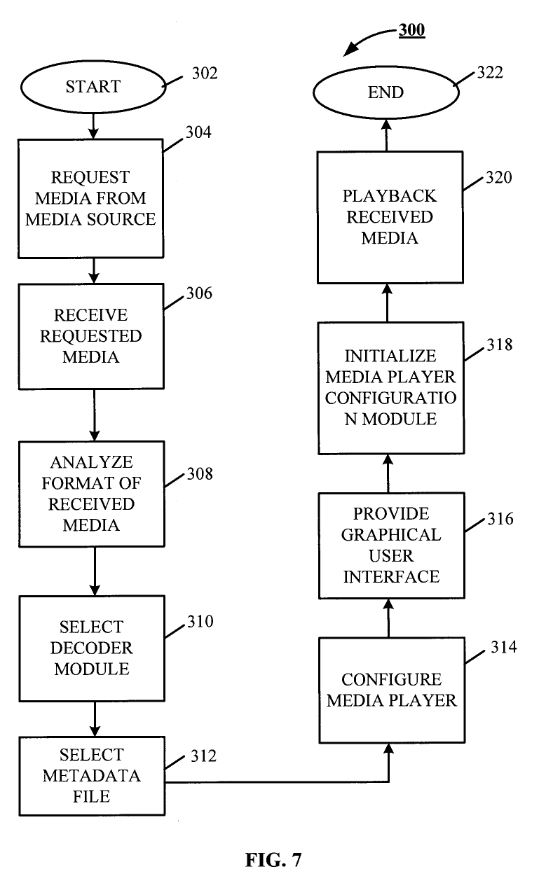

Continuing with FIG. 7, shown therein is a flow chart 300 that depicts process steps of an alternate method of using a self configuring media playback system. The method commences at start process step 302 and proceeds to process step 304 with requesting a media from a media source. At process step 306, the requested media is received into a playback device, and analyzing to determine in which format of the received media is presented at process step 308.

At process step 310, a decoder module is selected from a plurality of decoder modules based on the type of media received, and at process step 312, metadata file is selected from a style sheet module, based on the selected decoder module. At process step 314, a media player control is configured on the fly based on the selected decoder module and the selected metadata file.

At process step 316, a graphical user interface is provided on a graphical display device communicating with a processor and responsive to a pointing device for use by a user in playing back the received media. At process step 318, a media player configuration module is initialized to configure the media player control on the fly based on the selected decoder module and metadata file. At process step 320, the received media is played back upon a command from the user, and the process concludes at end process step 322.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed by the appended claims.

What is claimed is:

1. A device comprising:
a processor programmed with media request software;
a network interface device communicating information between the processor and a network; and
a non-volatile information storage medium responsive to the processor and loaded with media player program logic responsive to and interacting with the media request software, and a media player object library supporting a plurality of media player decoder modules responsive to and interactive with the media player program logic, wherein upon receipt by the network interface device of media requested from the network, the media player program logic analyzes in which format the received media is presented, and automatically selects a media player decoder module from the plurality of media player decoder modules for playback of the received media.

2. The device of claim 1, further comprising:
a graphical display device responsive to the processor; and
a media player control loaded onto the non-volatile information storage medium, responsive to the media player program logic, and interacting with the graphical display device to provide a graphical user interface for use by a user in playing back the received media.

3. The device of claim 2, further comprising a media player configuration module loaded onto the non-volatile information storage medium and interacting with the media player program logic, the media player configuration module integrating the selected media player decoder with media player control for use by the user in playing back the received media.

4. The device of claim 3, further comprising a pointing device communicating with the processor and interacting with the media player control, wherein the user interacts with the graphical display device via manipulation of the pointing device to stimulate the media player control to playback the received media.

5. The device of claim 1, in which the media player logic comprises media format recognition logic module interacting with the media request software for use in analyzing which format the received media is presented.

6. The device of claim 5, further comprising:
a graphical display device responsive to the processor; and
a media player control responsive to the media player program logic and interacting with the graphical display device to provide a graphical user interface for use by a user in playing back the received media, the media player control loaded onto the non-volatile information storage medium.

7. The device of claim 6, further comprising a media player configuration module loaded onto the non-volatile information storage medium and interacting with the media player program logic, the media player configuration module integrating the selected media player decoder with media player control for use by the user in playing back the received media.

8. The device of claim 7, further comprising a pointing device communicating with the processor and interacting with the media player control, wherein the user interacts with the graphical display device via manipulation of the pointing device to stimulate the media player control to playback the received media, and in which the pointing device comprises a touch screen.

9. The device of claim 1, in which the media player logic comprises a style sheet module providing a plurality of metadata files, wherein each metadata file provides specific presentation control information for use in controlling playback of the received media.

10. The device of claim 9, in which the media player logic comprises media format recognition logic module interacting with the media request software for use in analyzing which format the received media is presented.

11. The device of claim 10, further comprising:
a graphical display device responsive to the processor; and
a media player control responsive to the media player program logic and interacting with the graphical display device to provide a graphical user interface for use by a user in playing back the received media, the media player control loaded onto the non-volatile information storage medium.

12. The device of claim 11, further comprising a media player configuration module loaded onto the non-volatile information storage medium and interacting with the media player program logic, the media player configuration module integrating the selected media player decoder with media player control for use by the user in playing back the received media.

13. The device of claim 12, further comprising a pointing device communicating with the processor and interacting with the media player control, wherein the user interacts with the graphical display device via manipulation of the pointing device to stimulate the media player control to playback the received media.

14. A method by steps comprising:
programming a processor with media request software;
providing a network interface device communicating information between the processor and a network;
loading media player logic on a non-volatile information storage medium responsive to the processor, wherein the media player logic is responsive to and interacting with the media request software;
loading onto the non-volatile information storage medium a media player object library supporting a plurality of media player decoder modules responsive to and interactive with the media player program logic;
requesting media from the network via the media request software;
receiving media requested from the network;
analyzing in which format the received media is presented using the media player program logic; and
automatically selecting a media player decoder module from the plurality of media player decoder modules for playback of the received media.

15. The method of claim 14, by steps further comprising:
engaging the processor with a graphical display device responsive to the processor; and
loading onto the non-volatile information storage medium a media player control responsive to the media player program logic and interacting with the graphical display device, the media player control providing a graphical user interface for use by a user in playing back the received media.

16. The method of claim 15, by steps further comprising:
loading a media player configuration module onto the non-volatile information storage medium; and
integrating the selected media player decoder with media player control for use by the user in playing back the received media interacting with the media player program logic by initiating the media player configuration module.

17. The method of claim 16, by steps further comprising:
engaging the processor with a pointing device; and
manipulating the pointing device to stimulate the media player control to playback the received media.

18. The method of claim 17, by steps further comprising:
loading a format recognition logic module onto the non-volatile information storage medium; and
analyzing which format the received media is presented with the format recognition logic module.

19. A method by steps comprising:
requesting a media from a media source;
receiving the requested media into a playback device;
analyzing a format of the received media;
selecting a decoder module from a plurality of decoder modules;
configuring a media player control on the fly based on the selected decoder module; and
playing back the received media upon a command by a user.

20. The method of claim 19, by further steps comprising:
selecting a metadata file from a style sheet module based on the selected decoder module;
configuring the media player control with specific presentation control information on the fly based on the metadata file;
initializing a media player configuration module to configure the media player control on the fly based on the selected decoder module and metadata file; and
providing a graphical user interface on a graphical display device communicating with a processor and responsive to a pointing device for use by a user in playing back the received media.
